(19) United States
(12) Patent Application Publication
(10) Pub. No.: US 2008/0133275 A1
(43) Pub. Date: Jun. 5, 2008

(54) SYSTEMS AND METHODS FOR EXPLOITING MISSING CLINICAL DATA

(75) Inventors: Peter J. Haug, Salt Lake City, UT (US); Jau-Huei Lin, Sandy, UT (US)

Correspondence Address: MADSON & AUSTIN, 15 WEST SOUTH TEMPLE, SUITE 900, SALT LAKE CITY, UT, 84101, US

(73) Assignee: IHC Intellectual Asset Management, LLC, Salt Lake City, UT (US)

(21) Appl. No.: 11/945,933

(22) Filed: Nov. 27, 2007

Related U.S. Application Data
(60) Provisional application No. 60/867,501, filed on Nov. 28, 2006.

(51) Int. Cl. G06Q 50/00

(52) U.S. Cl. 705/3

(57) ABSTRACT

A method for providing information to a clinician regarding a patient's medical problems based upon a combination of the information recorded in the medical record and information omitted from the medical record is described. A patient's medical record is obtained. The medical record may include information regarding the medical conditions experienced by the patient, information from a clinician's observations of treating or testing the patient, and results from tests or therapies administered to the patient. A computer system having a decision support system is used. The decision support system comprises a prediction engine. The decision support system is used to predict conditions or problems omitted from the patient's medical record. These predictions are then provided to the clinician for recording into the medical record.

### RELATED APPLICATIONS

This application claims the benefit of U.S. Provisional Patent Application Ser. No. 60/867,501 entitled “Exploiting Missing Clinical Data” which was filed Nov. 28, 2006. This application is expressly incorporated herein by this reference.

### TECHNICAL FIELD

The present disclosure relates generally to computer systems and computer-related technology in the medical field. More specifically, the present disclosure relates to computer systems that are designed to provide additional information to a health care provider by exploiting clinical data missing from patient health records.

### BACKGROUND

It has long been known that clinicians and other health care providers make medical records of a patient's visit. In general, the purpose of these records is to document the patient's problems, symptoms, etc. as a means of assisting the clinician(s) and health care providers (referred to as clinicians herein) in providing treatment. Such health records are also valuable to other clinicians who may provide treatment to the patient in the future.

With the advent of the computer age, these health records are often kept in an electronic format (and are thus referred to as “Electronic Health Records” or “EHRs”). (The terms “EHR” and “electronic medical record” or “EMR” are used interchangeably in the industry.) One of the advantages of EHRs is that they may be easily stored as part of a database at a central location and may be accessed by a variety of clinicians each time the patient visits a clinic. Moreover, information regarding each particular clinic visit may be added to the EHR, thereby providing the clinician with a “running log” of the patient's conditions/problems. Such data regarding the patient, his/her medical history, past conditions, prior visits, etc. is valuable information that may assist a caregiver in treating chronic problems, meeting the patient's health care needs, etc.

Some of the most useful types of medical records for patients are the “problem-oriented medical records” or “POMR”. These type of records were proposed and studied during the 1960s and constitute a simple way for the clinician to organize complex medical information. In making a POMR, the clinician maintains a list of the patient's medical problems. As medical care is documented, the clinician can relate the accumulating medical data to each problem and can assess the patient's condition in terms of the problems recorded. Plans for treatments or further evaluation are described in the context of the patient's problems. POMRs are extremely useful in the context of EHRs because the EHR (as noted above) may simply be updated, over time, to show all of the patient's problems and medical conditions. Accordingly, many health care networks are beginning to advocate and use EHRs that are focused on the patient's problems.

A key challenge associated with the use of EHRs is the inconsistent character of the clinical data entered into EHRs. The timing, sequence, amount, and other characters of the data collected for the EHR can vary greatly from patient to patient and from clinician to clinician. Sometimes certain data may not be included in the EHR. There may be various reasons for the omission of the data from the EHR. For example, the clinician may have decided that a test, reading or other data was not needed based on the context of the medical situation. Another reason for the omission of the data from the EHR may simply be that the clinician forgot to make the proper record or became busy with other patients such that he or she simply forgot to make the appropriate record.

Unfortunately, the inconsistent entry of data into EHRs makes the data difficult to use and manipulate. Oftentimes, computer systems (programs) designed to analyze data in the EHRs cannot function properly and/or analyze a particular record because key data has been omitted from the record. For example, a decision rule or an algorithm in the computer program may require a serum amylase measurement to be present in order for a certain function to occur. If no serum amylase has been ordered for the patient, or if the clinician has failed to enter the appropriate data regarding serum amylase into the patient's file, then the absence of this data may prevent that program from properly analyzing/processing the record.

Accordingly, there is a need in the art for a new system that can manipulate EHRs, even when information is omitted and/or missing from the EHR. Moreover, there is a need for a system that can appropriately fill in “missing” data into an EHR so that this data may be used by a clinician. Additionally, there is a need for a system that can appropriately account for and adjust the interpretation and assessment of collective data when certain data in the EHR is missing or omitted. Further, it would be beneficial if a system was designed to extract valuable, usable information for the clinician from a combination of the present and the missing data in the EHR. Such a system is disclosed herein.

### BRIEF DESCRIPTION OF THE DRAWINGS

FIG. 1 is a diagram illustrating an embodiment of a system according to the present embodiments that includes a Decision Support System (DSS) that is capable of predicting values for data missing from an electronic health record;

FIG. 2 is a flow diagram illustrating the method by which the DSS of FIG. 1 may predict values for data missing from an electronic health record;

FIG. 3 is a diagram of another embodiment of a system that includes a DSS that is capable of predicting values for data missing from an electronic health record;

FIG. 4 is a diagram of one embodiment of an electronic health record in an electronic database;

FIG. 5 is a diagram of another embodiment of an electronic health record in an electronic database;

FIG. 6 is another embodiment of a computer system including a DSS that is capable of predicting values for data missing from an electronic health record;

FIG. 7 is a flow diagram of an embodiment of a method of building and using a Bayesian Network that may be used as part of a prediction engine;

FIG. 8 is an embodiment of a data set that may be used to train a prediction engine (which may be Bayesian Network) to predict whether the patient has pneumonia;

FIG. 9 is a flow diagram illustrating an embodiment for treating data so that this data may be used to train a prediction engine of the present embodiments;

FIGS. 10A and 10B are flow diagrams representing one embodiment of a Bayesian Network that may be used in the present embodiments, in which FIG. 10A discloses the structure of the Bayesian Network whereas FIG. 10B discloses the parameters of the Bayesian Network;

FIG. 11 is a flow diagram illustrating an embodiment of a Bayesian Network that may be used in the present embodiments that has been created based upon causal relationships observed by a human;

FIG. 12 is a flow diagram illustrating one embodiment of the way in which data may be taken and then used to train a Bayesian Network;

FIG. 13 is a flow diagram of one configuration of a method for continuously updating a problem list in an electronic health record; and

FIG. 14 is a block diagram illustrating the major components of a computer system typically utilized with embodiments herein.

### DETAILED DESCRIPTION

A method for providing information to a clinician regarding a patient's medical problems based upon a combination of information recorded in the medical record and information missing from the medical record is disclosed. The method comprises the step of obtaining a patient's medical record. The medical record comprises information regarding the medical conditions experienced by the patient, information from a clinician's observations of treating or testing the patient, and results from tests or therapies administered to the patient. The method also includes the step of obtaining a computer system having a decision support system, wherein the decision support system comprises a prediction engine. The method further includes the step of using the decision support system to predict conditions omitted from the patient's medical record. The method also includes the step of providing these predictions to the clinician for recording into the medical record. The method may further include the step of training the decision support system (DSS) using historical data prepared using mechanisms that make the information embedded in the missing data available to the system

In some embodiments, the prediction engine, which may be a Bayesian network, may identify conditions omitted from the medical records. If the prediction engine is a Bayesian network, the method may include the step of testing sensitivity and specificity of the predictions provided by the Bayesian network. Such testing of the sensitivity and specificity of the Bayesian network is tested by creating an ROC curve. Embodiments may be designed in which the prediction engine is trained using information from a database of medical records.

In other embodiments, the method may include the step of adding a missingness indicator to the patient record to signal to the prediction engine that this value is absent from the medical record. Further embodiments may be designed in which the decision support system further comprises an output engine that outputs the value predicted by the prediction engine to the clinician. In some cases, the prediction engine may make predictions in a target variable based upon values for non-target variables that are known to have a causal relationship with the target variable.

A computer system is also disclosed. The computer system is configured to provide information to a clinician regarding a patient's medical problems based upon a combination of information recorded in the medical record and information missing from the medical record. The system comprises a processor, memory in electronic communication with the processor, and instructions stored in the memory, the instructions being executable to obtain a patient's medical record that is stored in a database. The medical record comprises information regarding the medical conditions experienced by the patient, information from a clinician's observations of treating or testing the patient, and results from tests or therapies administered to the patient. The instructions are also executable to predict a value for conditions omitted from the patient's medical record using a prediction engine that is part of a decision support system, and then provide these predictions to the clinician for recording into the medical record.

Embodiments of the system may be designed in which the prediction engine comprises a Bayesian network that has been trained to make predictions from the information found in the database. The database may be located remotely from the system. Other embodiments of the system may be designed in which the prediction engine makes predictions in a target variable based upon values for non-target variables that are known to have a causal relationship with the target variable. Further embodiments of the system may be designed in which the predictions from the engine are sent to the clinician via an output engine.

The present embodiments also relate to a computer-readable medium. This medium comprises executable instructions to obtain a patient's medical record that is stored in a database, predict a value for conditions omitted from the patient's medical record using a prediction engine that is part of a decision support system, and provide these predictions to the clinician for recording into the medical record. The medical record is an electronic medical record comprising information regarding the medical conditions experienced by the patient; information from a clinician's observations of treating or testing the patient; and results from tests or therapies administered to the patient. In some embodiments, the prediction engine comprises a Bayesian network that has been trained to make predictions from the information found in the database. The prediction engine may make predictions in a target variable based upon values for non-target variables that are known to have a causal relationship with the target variable.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

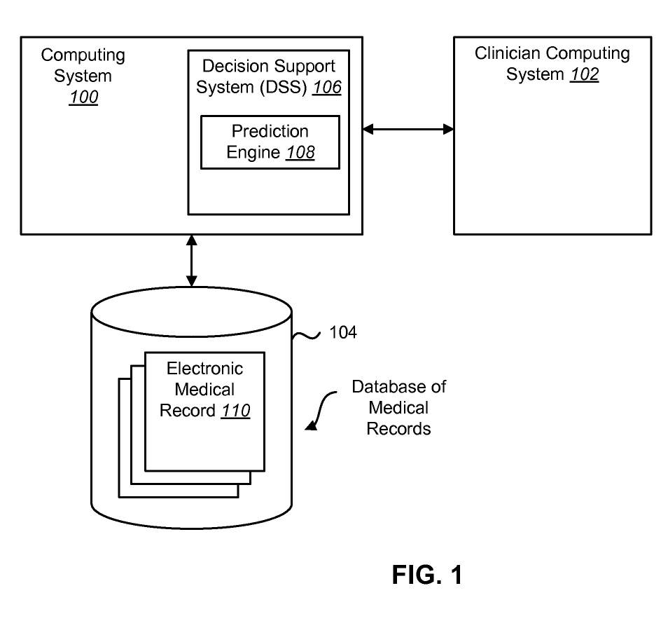

FIG. 1 is a diagram illustrating an embodiment of a system according to the present embodiments that includes a Decision Support System (DSS) 106 that is capable of predicting values for data missing from an electronic health record. As shown, embodiments disclosed herein may involve interaction between a computing system 100, a clinician computing system 102, and a database of medical records 104 (which is sometimes called the “database 104”). In typical embodiments, the computing system 100, the clinician computing system 102, and the database of medical records 104 are three distinct systems. However, in some embodiments, two or more of them may be combined. For example, the database 104 may reside on the computing system 100.

In other embodiments, there may only be a single computing system, called a “clinical computing system.” This generic computing system may include all the tools for data capture, data display/reporting, data management, and decision support. (In other words, the clinical computing system may be a combination of the computers 100, 102 and 104.) This clinical computing system may include the tools for maintaining the decision support system including machine learning tools to maintain the Bayesian network components.

The clinician computing system 102 communicates with the computing system 100. In the typical embodiment, the clinician computing system 102 resides in a patient care facility, such as a hospital, clinic, or “insta-care” facility. A clinician may access the clinician computing system 102 as part of a patient visit in order to quickly remind themselves of the current state of the patient's health and treatments. The clinician computing system 102 may also be used by a clinician to document any data collected and various other notes regarding the patient's care. Again, in the embodiments described above in which there is only one centralized “clinical computing system,” all of the information/services will be sent from the clinician computing system over a wide area network/internet to the health care provider.

In a typical embodiment, a database 104 of medical records 110 would reside in a centralized location. In the present systems and methods, the medical records 110 are electronic. The computing system 100 may access the database 104 at the request of the clinician computing system 102. Alternatively, the clinician computing system 102 may access the database 104 directly.

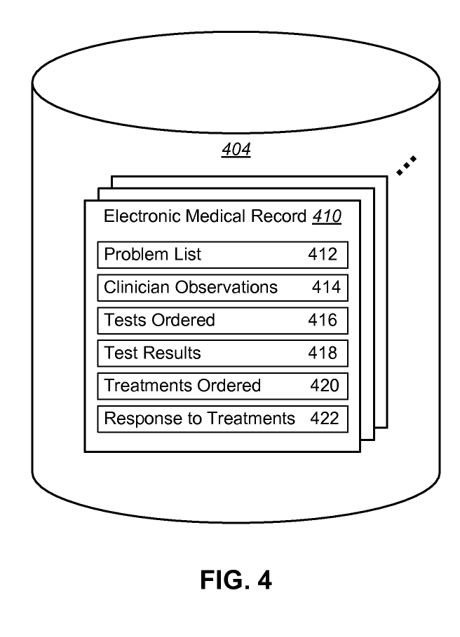

The medical records 110 in the database 104 contain information about the medical problems/conditions being experienced by the patient. As explained above, the medical record obtained will generally be an EHR (electronic health record) that is a problem-oriented medical record (POMR). (An embodiment of an EHR is also shown and described in conjunction with FIG. 4). Accordingly, this record will generally list the problems/medical conditions that the clinician has observed, problems/conditions currently being experienced by the patient or those that have been experienced in the past. Also, the observations of the clinician (such as the clinician's observations of the patient's condition, the patient's medical problems, the patient's responses to treatment, changes in the patient's conditions, orders for testing, consultation or therapy, etc.) may also be documented in the EHR. Further, clinical data from the laboratory, the radiology department, the pathology department, etc. may also be recorded in the EHR. (In fact, in some embodiments, it is appropriate to mine this clinical data for the missing data elements. In other embodiments, a curated copy of the data is moved into a second database (Enterprise Data Warehouse) in order to facilitate data mining.). The conditions/symptoms observed by the clinician or experienced by the patient may be documented in terms of the medical problems observed or experienced by the patient.

Generally, each particular record will be for an individual patient. Of course, as commonly occurs in hospitals, clinics, etc., all of the records will lack specific information/data that could have and/or should have been recorded by the clinician. (It may be inappropriate and/or impossible to collect all possible date for any patient).

The computing system 100 may include a Decision Support System (DSS) 106. One of the purposes of the DSS 106 is to detect medical problems by using clinical information in order to facilitate the completeness of problem lists. Thus, the DSS 106 may use the presence or absence of clinical data to infer the existence of clinical problems. The decision about whether a problem should be included in a problem list is made in the prediction engine 108 in the DSS 106.

The DSS 106 is a computer program (such as a software program) that assists the clinician. As noted above, the DSS 106 is an “expert system,” which means it uses information, heuristics, and inference to suggest solutions to problems. In particular, the DSS 106 is an expert system that can inspect raw clinical data and propose solutions to problems (that the patient may be experiencing) to clinicians as they maintain the EHR.

The proposed solution will be based upon all of the data/information available to the system, including the particular data entered into the medical records. This list of candidate medical problems will also be based upon inferences, predictions, etc. based upon information that is not present in the medical record (such as the lack of chest X-ray information as an indicator that pneumonia is not present, the lack of abdominal pain suggests that acute pancreatitis is not likely, etc). In the context of day-to-day care, missing variable values reflect data that are uncollected for a variety of reasons including omission, irrelevance, too much risk, or inapplicability in a specific context. For data elements that may be considered important for specific diagnoses or treatments, their absence generally means that the clinician does not consider those possible diagnoses relevant to the patient's condition.

The candidate list of problems generated by the DSS 106 serves two potential functions. One is to notify the clinician of a problem that he/she may have overlooked. The other is to remind the clinician of important problems that he/she may be aware of but may have neglected to record in the problem list. The overall goal of this expert system is to assist clinicians to record all medical problems and to facilitate the completeness and timeliness of the medical problem list.

The clinician may then use this information generated by the DSS 106 to bolster the patient's EHR to ensure that a complete, thorough, documented record is available. It should be noted that although the purpose of the DSS 106 is to detect medical problems by using clinical information, it is not intended to serve the same function as a computerized tool for diagnosis. Rather, the goal of the DSS 106 is to facilitate the completeness of the problem list rather than to exhibit diagnostic behavior similar to a clinician's. Thus, every piece of information that serves this purpose, including the clinician's recorded decisions, observations, and actions and the clinician's omitted decisions, observations, and actions, can and should be used to optimize the performance of the system. The system is designed not only to interpret the raw clinical data, but also to “look over the clinician's shoulder” and infer from his actions the problems that have motivated them. These are problems that should be recorded in the medical problem list of the EHR.

As described above, the DSS 106 operates to predict the patient's condition based upon known information (found in the medical record 110) as well as based upon inferences derived from the absence of specific information from the record 110. As shown in FIG. 1, the DSS 106 comprises a predictor engine 108. The predictor engine 108 is a portion of the software program that will predict and/or generate the conditions list that is based upon the inputs of data provided to the DSS 106. This predictor engine 108 may be of a variety of types, which are described herein. The prediction engine 108 is the expert system that will make inferences, predictions, etc. regarding the patient's condition. An important feature in determining the type and accuracy of the prediction engine 108 relates to how the engine 108 is trained to make predictions.

As will be described in greater detail herein, a variety of different types of algorithms may be used as the predictor engine 108. For example, one type of prediction engine 108 is an algorithm that will make predictions from the results obtained from a population sample that is made up of only complete medical records (i.e., those records that have all of the information completed through the time the patient is discharged from the hospital/clinic). In other embodiments, a population sample used to train the system may be based on records which are complete as of a set time period (i.e., 24 hours after the patient was admitted, 48 hours after being admitted, 15 minutes in the cardiac ICU, etc.). Further embodiments may be designed based on other subsets of data or other models for inference, as desired. For example, embodiments may be constructed in which the subset used to train the system is based upon the time the patient has been in the hospital. A system may be trained based upon a subset of data which is believed to provide an accurate prediction regarding the patient's condition (or based upon the way in which the data is to be used). Based upon this population sample of medical records, the prediction engine 108 (which is an expert system) can thus be trained to make predictions in the future for those medical records 110 which are incomplete. Unfortunately, the population of medical records 110 that are complete is a biased sample; thus, if the prediction engine 108 makes predictions based upon this biased sample, this type of prediction engine 108 often produces biased results.

The prediction engine 108 may also be trained to make predictions from a sample of incomplete medical records that have been “filled in” with estimations for the incomplete (omitted) values. For example, a population sample may be constructed in which all missing values are assigned a value (such as a “mean” or average value) that would be expected in the local population. Other similar population samples can be constructed in which the medical records that are filled in with values based upon a determined regression, or based upon some calculation which estimates the likelihood of the value (based upon prior testing, known data, etc.) From this sample of “filled in” records, the prediction engine 108 can be trained to make predictions (that are based upon this population sample) each time that the engine 108 encounters a medical record 110 that omits one or more values of data.

Unfortunately, making predictions based upon population samples that are entirely complete or have been “filled in” with estimated values are all based upon the underlying assumption that the mechanism leading to the omission of a particular data value from the medical record 110 is random and that no usable information can be derived from the absence of this data. However, as explained above, there are circumstances in which the omission of a particular value from a medical record 110 can provide the clinician with cogent information regarding the patient's medical condition. It is for this reason that other embodiments may be designed to use the omission of certain information from a medical record 110 as part of the prediction model.

For example, Bayesian networks and Bayesian systems can be developed which will actually use the omission of information from the medical record 110 as part of the prediction engine 108. Bayesian networks, or belief networks, are known for their ability to model uncertainty and the causal relationship between variables. In a Bayesian network, each variable is modeled as a node and the causal relationship between two variables may be represented as a directed arc. For each node, a conditional probability table or formula is supplied that can produce probabilities of possible values of this node, given the conditions of its parents. In other words, if a particular symptom/condition in the patient is present (or absent), in conjunction with one or more other values, the Bayesian network can judge the probability and likelihood that another condition will (or will not) be present in the patient.

The advantages of using Bayesian networks (BN's) (and the associated probability calculations) to model clinical expert systems include the following:
1) they can be used to predict a target variable in the face of uncertainty;
2) a causal relationship can be represented by an arc between two nodes and the conditional probabilities of the node, thereby providing a model that is intuitive to clinicians and that can be used to generate explanations; and
3) they can provide a valid output when any subset of the modeled variables is present, which, in effect, means that the expected values of all missing variables are inferred from the variables that are presented.

A variety of different Bayesian networks can be designed for use as the prediction engine 108. In general, these Bayesian networks take a sample of data from patients and then, using probabilities and the particular program, the presence of a particular disease/condition is calculated based upon other factors, data, etc. However, in order to make these calculations, specific “missingness indicators” may be added to the medical records 110. These missingness indicators tell the Bayesian network that such information is not known and inferences concerning other variables should be conditioned by the explicit absence of the indicated data.

The probabilities and calculating algorithms found in the Bayesian networks will allow the expert system to make statistically significant predictions regarding the presence or absence of a specific condition/problem, even when the medical record is incomplete. Generally, the specificity and sensitivity of each particular Bayesian network may be obtained and analyzed by graphing the results (such as by creating a receiver operating characteristic (ROC) curve or other similar graphs). A receiver operating characteristic (ROC) curve is a graphical plot of sensitivity versus false positive rate (1-specificity) for a classification system designed to detect the presence or absence of a characteristic. It has the advantage of measuring the success of the system over a variety of detection thresholds. In some cases, these thresholds are different probabilities for a disease or condition at which a clinician might choose to assign that disease or condition to the patient. The methods for creating these ROC curves involve standard techniques (in the data mining field) and/or other known procedures. Depending upon the particular embodiment, “bootstrapping” and/or other data manipulation techniques may be required to provide meaningful, usable, results.

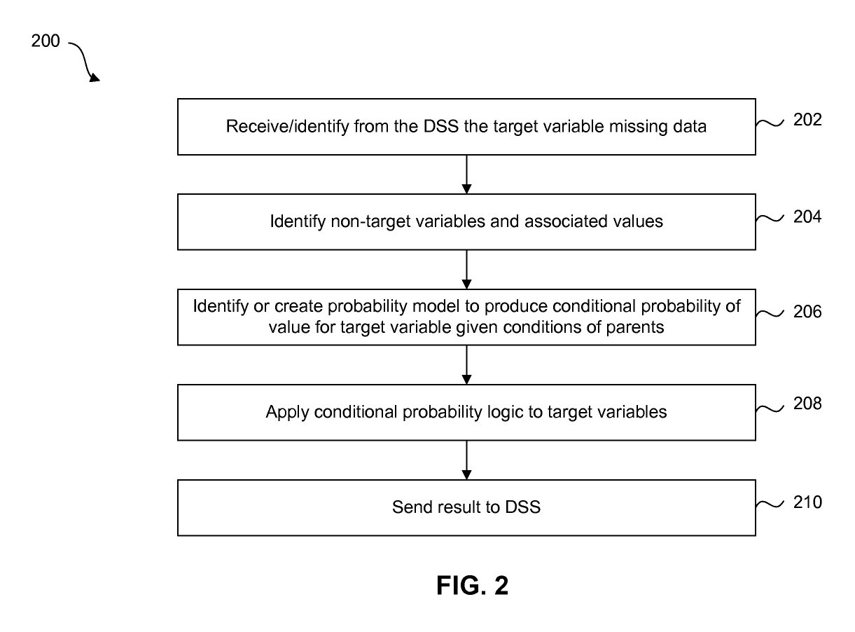

FIG. 2 is a flow diagram illustrating the method by which the DSS 106 of FIG. 1 may predict values for data missing from an electronic health record. Specifically, FIG. 2 is a flow diagram illustrating a method 200 that may be performed by an embodiment of the prediction engine 108 within the DSS 106. Initially, the prediction engine 108 receives 202 the target variable from the DSS 106. The target variable may be a disease that is not in the problem list or a piece of clinical data, such as respiratory rate. Next, the non-target variables with causal relationships to the target variable and associated values may be identified 204. For instance, if the target variable is a patient's respiratory rate, then the non-target variables might be pneumonia and asthma. It should be noted that the target variable may be any problem or piece of clinical information that is not listed in the EHR. Those which are listed above are simply given as exemplary embodiments. (The relationship between the target variables and the non-target variables is described in greater detail herein).

The system may be triggered to identify non-target variables and/or associated values in two ways. In one case, the systems are run at specific points in time (for instance, 6 hours, 12 hours, 18 hours, and 24 hours after admission). The other approach is to trigger them when a key variable is added to the electronic medical record. For example, a white blood count or a sputum culture might trigger a module that evaluates the likelihood of pneumonia. The system can, of course, be triggered by a direct request submitted by a user through an application.

Upon being triggered, the system will go to the EHR, extract the data that has been associated with it, assign the value of “missing” as appropriate, and then run the detection algorithm to determine if the disease/condition is present.

As can be shown in FIG. 2, the method 200 may also include either identifying or creating 206 a conditional probability model for the target variable given the conditions of the non-target variables. As explained above, a BN may be used as an effective conditional probability model. The conditional probability model may then be applied 208 to the target variables and the results sent 210 to the DSS. It should be noted that the development of the model is done in a training environment. In this training environment, all parameters associated with missingness are estimated. When used real time in the clinical system, all of the parameter determination required for the system to function is already complete.

Once the result is sent to the DSS, this result (generated by the prediction engine 108) may be provided to the clinician. The functionality used to provide the information to the clinician may be implemented in various ways to be capable of outputting information generated by the prediction engine 108 and may take the form of computer hardware, computer software, and/or combinations thereof. In some embodiments, this may specifically be an application with a user interface (“UI”) appropriate to provide the inferred information to the clinician. Various types of UIs are possible. In other embodiments, the program may run in the background and may add a note to a table (or some other type of database or note-receiver) and then the database front end or note-receiver may alert or notify the clinician of the added material at an appropriate time.

There may actually be embodiments in which the system does not show this result to a clinician. The information generated about a condition or the probabilities could be used internally as a part of other processing (i.e. determination of orders to propose to the clinician as a part of a computerized order entry system).

Thus, as can be seen from FIGS. 1 and 2, the present embodiments provide for a method that will allow a clinician to examine a patient's medical problems based upon a combination of the information recorded in the medical record and information omitted or missing from the medical record. This method may involve obtaining the EHR from the database, wherein the medical record comprises information regarding the medical conditions and problems experienced by the patient, information from clinicians' observations who have treated or tested the patient, results from tests and therapies administered by the patient, and/or any other type of conditions/problems that have been observed in the patient. The method also includes the step of obtaining a computer system having a decision support system (that includes a prediction engine) and then using this decision support system to predict conditions or problems omitted from the patient's medical record. Once the prediction(s) have been made, the predictions are provided to the clinician for recording into the medical records. The present embodiments may be stored as executable instructions and data on a computer-readable medium that will implement the above-recited methods.

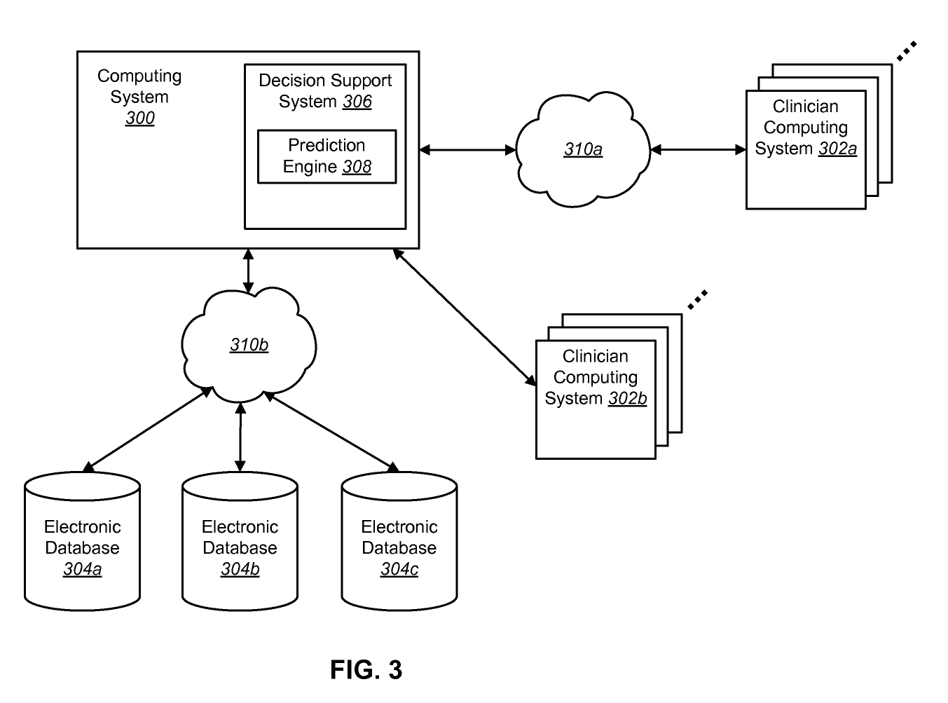

FIG. 3 is a diagram of another embodiment of a system that includes a DSS 306 that is capable of predicting values for data missing from an electronic health record. As before, there may be a computing system 300 with a DSS 306 and a prediction engine 308. In the present embodiment, there are multiple clinician computing systems 302 and databases 304 connected to the computing system 300. The clinician computing systems 302b may be connected directly to the computing system 300 with the DSS 308. Alternatively, the clinician computing systems 302a and databases 304 may be connected via a different communication path 310 (e.g., the Internet, a LAN, a WAN, etc.). In some embodiments there may be more than three databases 304, each connected to the computing system 300 through different communication paths 310. It should be noted that FIG. 3 resembles an application service provider (ASP) model (i.e., the clinical computing system) that was discussed above for delivering decision-support across the Internet.

FIG. 4 is a block diagram of one embodiment of an electronic medical record (“EMR”) 410 in a database 404. The EMR 410 may contain a problem list 412 that organizes patient data according to problems. In this way, the problem list 412 helps clinicians organize complex medical data, focuses attention on each medical problem, and promotes treatment of the patient according to a structured and documented analysis. The EMR 410 may also have clinician observations 414, tests ordered 416, test results 418, treatments ordered 420, and patient response to treatments 422. Alternatively, these may be included as part of the problem list 412 itself.

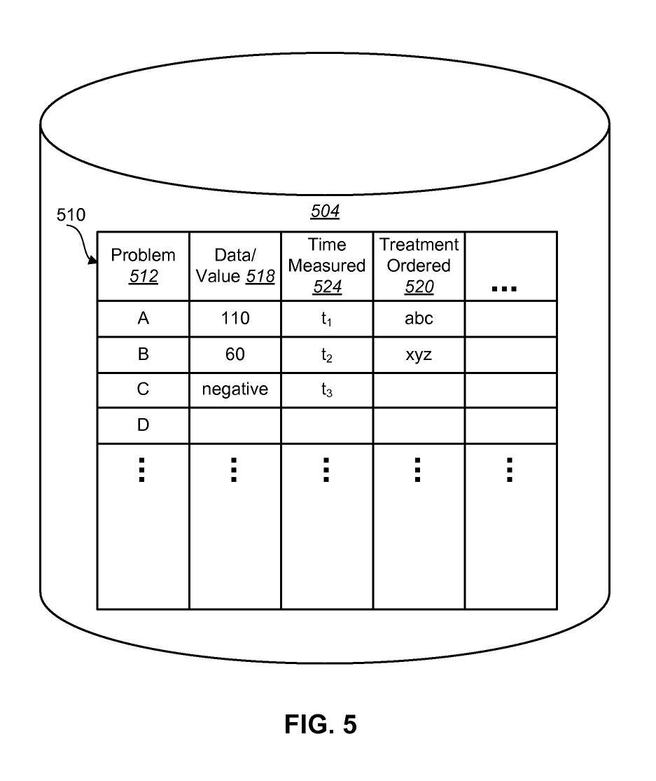

FIG. 5 is another embodiment of an EMR 510 in a database 504. The EMR 510 may have a problem list 512 with associated values 518 for test results or clinician observations. Also, the EMR 510 may document the time 524 at which the values 518 were gathered and any treatments ordered 520. Some of this information may be quantifiable in numerical values (such as the person's blood pressure, amount of oxygen in the blood, etc.). In other embodiments, the value may not be a “quantifiable” numerical value, but will, instead, be a description of the problem (such as, for example, “heavy coughing,” abdominal pain”, “pancreatitis”, “family history of cystic fibrosis” etc.). In the case of non-quantifiable data, some amount of natural language processing may be necessary. Additionally, data may be missing from the EMR 510. When data is missing, one of several treatments may be applied to the EMR 510. These data treatments will be discussed in detail below.

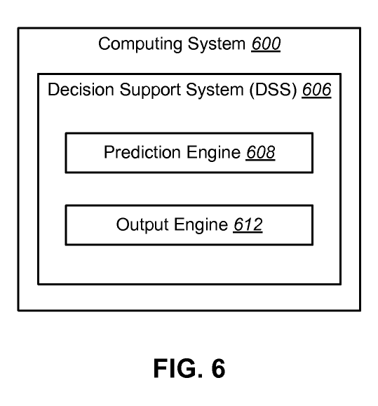

FIG. 6 is another embodiment of a computer system 600 including a DSS 606 that is capable of predicting values for data missing from an electronic health record. As described above, the computing system 600 may include a DSS 606 which operates to predict the patient's condition based upon known information (found in the EMR) as well as based upon inferences derived from the absence of specific information from the EMR. The DSS 606 is a computer program or application that is running on the computing system 600.

As shown in FIG. 6, the DSS 606 may include a prediction engine 608. The prediction engine 608 is a portion of the software program that will predict and/or generate the conditions list that is based upon the inputs of data provided to the DSS 606. The prediction engine 608 is the expert system that will make inferences, predictions, etc. regarding the patient's condition. When implemented as a Bayesian network, the prediction engine 608 applies the conditional probability model to the task of detecting clinical problems/conditions.

The DSS 606 may also include an output engine 612. After the prediction engine 608 has applied the conditional probability model to the data received from the computing system 600/EHR, the output engine 612 may then provide the result, or the probability that the target diagnoses/condition should be included in the problem list, to the clinician.

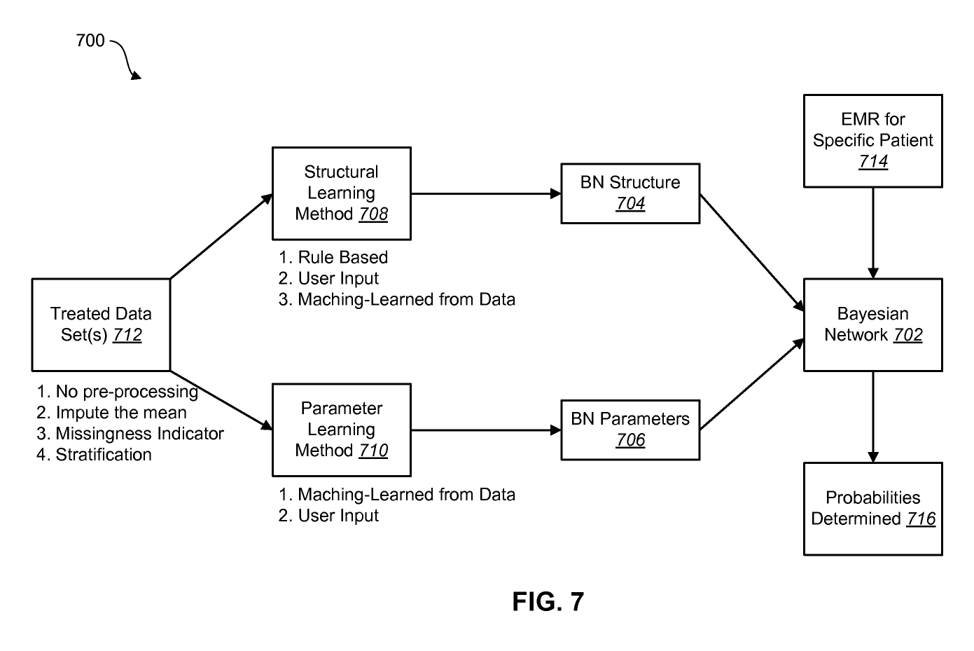

FIG. 7 is a flow diagram 700 of the process of building and using a BN 702. As discussed previously, a BN 702 is a type of conditional probability model, meaning that it infers the value of missing data from the value of known data. A BN 702 may be built in the prediction engine of the DSS. Alternatively, an appropriate BN 702 may be identified from a set of existing BNs and used to update a problem list rather than creating a new one every time one is needed.

It should be noted that a complete decision support system typically has a separate subsystem used for authoring and/or developing decision-support modules. In this case, the subsystem would include a component for developing Bayesian networks from datasets that included properly designated “missing” data elements.

A BN 702 may include two components: a structure 704 and parameters 706. In a BN 702, each variable is modeled as a node and the causal relationship between two variables may be represented as a directed arc. The series of causal relationships illustrated as nodes with arcs is the structure 704 of the BN. For each node, a conditional probability table or formula is supplied that represents the probabilities of each value of this node, given the conditions of its parents (i.e. all the nodes that have arcs pointed to this node). These conditional probabilities are the parameters 706 of the BN 702. It should be noted that in many embodiments, the Bayesian network structure (704) needs to be determined before the parameters (706) can be estimated. Accordingly, in these embodiments, the network structure 704 and the parameters 706 are generally organized in series.

The structure 704 is learned from a structural learning method 708, which may include one of several learning methods. It may be a rule-based learning method. For example, in one embodiment, all the independent variables may be parent nodes of the dependent variable. Another learning method may involve accepting user input. In this learning method, a structure is composed by a user using medical domain knowledge, possibly a clinician. This learning method emphasizes a “causal” model of disease; arrows may be placed from the disease/condition to each node representing a variable whose abnormalities are typically caused by that disease. In yet another learning method, the structure 704 is machine-learned from a treated data set 712. This involves a software tool that attempts to learn the optimal structure of the BN 702 from the treated data set 712. A toolkit such as “WinMine” (which is provided by Microsoft Corporation of Redmond Wash.) may be used for this embodiment.

Similarly, parameters 706 of the BN 702 may be learned from a parameter learning method 710, which may include one of several learning methods. This learning method may involve user input. In this learning method, parameters are composed by a user using medical domain knowledge, possibly a clinician. However, as the complexity of the network increases, this can become very demanding of the user's time (and may be impossible due to the complex of the underlying structure). Alternatively, the parameters 706 may be machine-learned from a treated data set 712. This involves a software toolkit that is capable of learning the conditional probability tables from the treated data set 712. One such example of this type of software is the Netica® program. The Netica® program is a Bayesian Network software program available from the Norsys Software Corp., 2315 Dunbar Street, Vancouver BC Canada V6R3N1. (The Netica® program is given as only one example of this type of software. Other software programs may likewise be used.)

The BN structure 704 combines with the BN parameters 706 to form the BN 702. One or both of the BN structure 704 and BN parameters 706 may be constructed in the present systems and methods. Alternatively, one or both may be simply identified from a set of existing structures and parameters and used to build the BN 702. Also, the structural learning method 708 used to construct the structure 704 may or may not be the same as the parameter learning method 710 used to construct the parameters 706 of the BN 702. For example, the structure 704 may be built from user input and combined with parameters 706 that are machine-learned to build the BN 702. Alternatively, both the structure 704 and the parameters 706 may be constructed from the same or similar learning methods using an application or applications designed for this purpose.

The data set or sets that may be used to build the structure 704 or parameters 706 of the BN 702 may have been transformed, treated, or both. In a typical embodiment, a data set 712 is directed to one target variable and includes both a positive and negative population. Different methods may be employed for compiling the positive and negative populations. For instance, a positive population may be defined as patients with the target variable as their primary diagnosis. Negative patients may then be defined as patients without the target variable as their primary diagnosis. The positive and negative patient populations may then be combined and transformed in any way necessary for general machine learning algorithms. Such transformations may include, but are not limited to, aggregation, attribute selection, and data pivoting as seen in Table 1. Table 1 (a) is the unpivoted data before attribute selection. Table 1 (b) is the pivoted table after attribute selection:

TABLE 1

| ID | Code | Value | Time |
|---|---|---|---|
| a001 | (BUN) | 60.0 | t1 |
| a001 | (CRE) | 4.0 | t1 |
| a001 | (WBC) | 8.5 | t1 |
| a001 | (WBC) | 9.5 | t2 |
| a002 | (CRE) | 1.0 | t3 |
| a002 | (WBC) | 12 | t3 |
| . | . | . | |

| ID | BUN | CRE | WBC |
|---|---|---|---|
| a001 | 60.0 | 4.0 | 8.5 |
| a002 | ? | 1.0 | 12.0 |
| . | | | |
| . | | | |
| . | | | |

(a) ‘(BUN)’ refers to the PTXT code for ‘BUN’.
(b) ‘?’ refers to the data element is nissing.

After the data set or sets 712 have been transformed to enable machine-learning, the data set(s) 712 are treated for missing values. This treatment may involve no treatment, imputing a missing value, providing an explicit missingness indicator, or stratification. These missing value treatments will be discussed in more detail below. Once the data sets 712 have been treated, they may be used to “train” the BN 702, or in other words, be used to build the structure 704 or the parameters 706 of the BN 702, if the respective learning methods require it.

After the structure 704 and the parameters 706 of the BN 702 have been combined to create the BN 702 or the BN 702 has otherwise been identified, the BN 702 may be applied to an EMR 714 for an individual patient. The probability that the target variable should be included in the patient's problem list is then determined 716. In this way, a data set 712 including many sets of patients' data is used to train a BN 702 which is then applied to an individual patient to help the clinician maintain an accurate and current problem list for the individual patient.

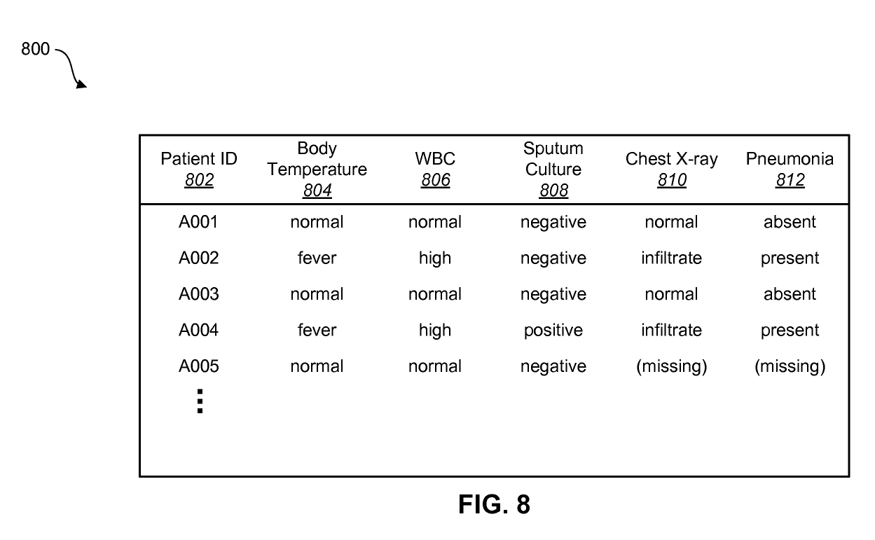

FIG. 8 is an exemplary embodiment of a data set that may be used to train a prediction engine (which may be a Bayesian Network) so that this prediction engine is capable of predicting whether the patient has pneumonia. Specifically, FIG. 8 is an embodiment of a data set 800 that could be used to build a model that can detect pneumonia. In this embodiment, pneumonia is the target variable and body temperature 804, WBC (white blood cells) 806, sputum culture 808, and chest x-ray 810 are the non-target variables with causal relationships to the presence or absence of pneumonia. The data set 800 includes a patient identifier 802 for each patient as well as a value for each of the non-target variables.

In order to do the type of supervised learning that is available using a BN, FIG. 8 includes an additional column that indicates the presence or absence of pneumonia. This information may be used to train the BN to make predictions (as described herein) regarding the presence/absence of pneumonia given other conditions. For example, in FIG. 5, patient A005 does not have any data input regarding the presence/absence of pneumonia. However, as explained herein, the BN may be able to predict this data.

The significance of FIG. 8 is that it shows how data mining techniques and statistical interference may be used to create a prediction engine. It is known that the mechanisms that lead to missing data can be categorized into three types: missing completely at random (MCAR), missing at random (MAR), and not missing at random (NMAR). Herein is used a simplified data set (Table 1) to explain these three mechanisms. The data set includes patients' data of four variables: body temperature, white blood cell count (WBC), sputum culture result, and chest x-ray result. Each record in the data set contains four values corresponding to these four variables of a patient. This data set can be used to build a prediction model that can detect pneumonia. Some patients' chest x-ray results are not present.
MCAR: The absence of a data element is not associated with any other value in the data set, observed or missing. In the example data set, if the chest x-ray results are missing by a random sampling process, then the missing mechanism is MCAR. In this case, observing the missingness will not provide information in addition to observed values.
MAR: This is a less restrictive assumption than MCAR; it indicates that the absence of a data element depends only on the observed values in the data set, not on missing ones. For the sample data set, if the x-ray results are missing only for patients whose body temperature is normal, WBC count is normal, and sputum culture is negative, then the missing mechanism is MAR. The implied information of missingness can be inferred from observed values.
NMAR: The condition is the negation of MAR. The absence of a data element reflects its probable (missing) data value. If the missingness is due to some conditions related to the chest x-ray result, then the mechanism is NMAR. A physician may assess the lung's condition by subjective complaints and auscultation. These variables are not present in the sample data. A chest x-ray may not be considered necessary if the physician feels the patient's lungs are normal and, in most cases, this inference will be correct. The absence of chest x-ray does not depend on the observed data in the data set, but on the missing chest x-ray value guessed by the physician using some mechanism not reflected in the data. Under this circumstance, the missingness does contain information that cannot be inferred from observed values.

Several approaches to missing data have been used in developing trained diagnostic systems. If one does not consider the observation that the data is missing as a piece of supporting information, the methods for coping with missing values can be grouped into three main categories: inference restricted to complete data, imputation-based approaches, and likelihood-based approaches.

The simplest approach to missing values is to discard the cases with missing values and do the analysis based only on the complete cases. However, this results in a biased sample of complete cases because the absence of data is not a random process.

In imputation-based methods, the missing values are filled in and the resultant data can be analyzed as a complete data set. Commonly imputed values are based on the value of known cases: the mean of the variable in either the whole data set or in select data subsets, or an estimated value from regression procedures on known variables. Multiple imputation methods, i.e., filling with more than one value, have been developed to avoid biasing the variances of imputed variables.

Approaches exist that, rather than imputing data where values are missing, derive a prediction model by inferring the model's parameters from the existing data. Likelihood-based approaches are an example of these. They implement a model by attempting to find the set of model parameters that make the observed data most likely. The resulting system can then base future inferences on the parameters estimated in the context of that model. The expectation-maximization (EM) algorithm is commonly used for finding maximum likelihood estimates in the face of incomplete data.

All of the above methods are based on the assumption that the mechanism of missing data is ignorable (i.e., MCAR or MAR) and does not provide additional information. However, researchers have noticed that some mechanisms leading to missing data actually possess information, i.e., they represent NMAR, which are also called ‘non-ignorable’ missingness or ‘informative’ missingness. Since the missingness mechanism contains information independent of the observed values, it requires an approach that can explicitly model the absence of data elements. Two approaches are commonly used to represent missingness in data—missingness indicator and stratification. The former approach creates another dichotomous variable representing whether a variable has been observed; the latter fills the target variable with a nominal value, “missing”, if the variable has not been observed.

As taught herein, it is the use of this NMAR technique that allows the Bayesian network to be trained and the prediction engine to be generated. Continuing with the present example of FIG. 8, it is known that if a patient has pneumonia, the clinician will generally order a chest X-ray. Accordingly, if no data regarding a chest X-ray is found in the patient's EHR, it can be assumed that the treating clinician believed that the patient did not have pneumonia and that the patient was not experiencing the other symptoms/problems associated with pneumonia. Accordingly, the fact that information regarding a chest X-ray was absent from the EHR actually provides significant information regarding the patient's health. In other words, “knowing what you don't know” helps you make better inferences and that at least some of the mechanisms/reasons which result in data missing from an EHR are related to clinical conditions/circumstances that should not be ignored. Obviously, this effect is related to time. When the patient first enters the healthcare system all data is “missing”. The missing data takes on meaning as the caregiver evaluates the patient, has the opportunity to add/order the data, and chooses not to do it.

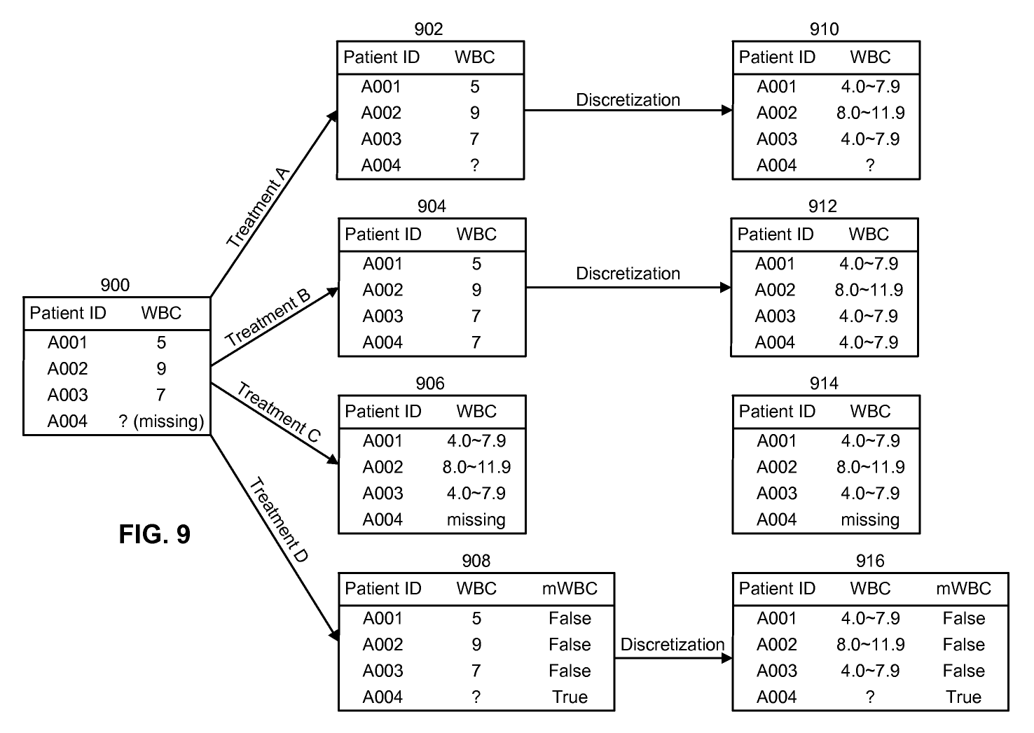

FIG. 9 is a flow diagram illustrating an exemplary embodiment for treating data so that this data may be used to train a prediction engine of the present embodiments. Specifically, FIG. 9 is an embodiment of four methods of applying missing value treatments to a data set 900. This example is given with respect to white blood cells. However, those skilled in the art will appreciate that any type of medical information or clinician observation(s) may be used. Each treatment begins with a data set 900 with a patient identifier for each patient and a white blood cell value. As discussed above, clinical data may be missing from a patient's EMR for a number of reasons. For instance, Patient A004 does not have a white blood cell value. These four treatments, A, B, C, and D, provide four different methods for dealing with missing values.

Treatment A provides no preprocessing to manage or infer missing values. Therefore, the resulting data set 902 is the same as the original data set 900.

Treatment B imputes the missing value with the overall mean or mode of all available values in the data set. In this case, the mean of all available values is “7”. Consequently, the missing value is replaced with “7” in the resulting data set 904.

Treatment C is an explicit missingness indicator approach. This indicator is an additional variable to represent missingness for each existing variable that was found to be absent in one or more patients. A discrete (nominal) value of “missing” is added to the variable after the other values were made discrete. The resulting data set 906 has only discrete values.

Treatment D is a stratification approach. A new dichotomous variable is added to the data set 908 and used to indicate the presence or absence of the value of the corresponding variable that might be missing.

After the treatments are performed, the data sets in Treatments A, B, and D may or may not go through binning discretization to produce discretized data sets 910, 912, and 916. Treatment C has already gone through discretization so further discretization is unnecessary 914. Treatment B creates a complete data set by imputing the mean of all available values while the structural and parameter learning methods are forced to deal with the missing values internally in Treatments A, C, and D.

A data set 900 may go through none, one, or more than one of these treatments in order to prepare the data set 900 to train the BN. Additionally, the data set may go through a modified variation of one of the treatments. However, once gathered in this manner, the data sets may be used to train a BN to be a predictor engine.

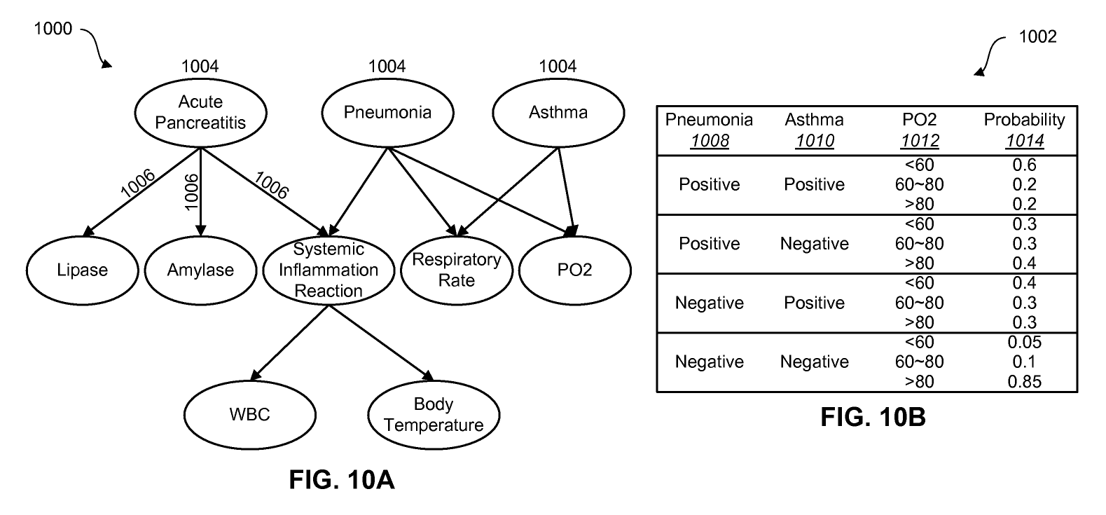

FIG. 10 is an embodiment of a BN. FIG. 10a is an embodiment of the structure 1000 of a BN while FIG. 10b is an embodiment of the parameters 1002 of a BN. A structure 1000 includes nodes 1004 and arcs 1006. A parent node is a node that points to another node, or child node. For instance, in the embodiment in FIG. 10a, the “Asthma” node is a parent of the “PO2” node and the “PO2” node is a child of the “Asthma” node. Some nodes, like the “Systemic Inflammation Reaction” node, may be both a parent and a child. An arc 1006 from one node to another represents a causal relationship between the two nodes.

Similarly, the parameters 1002 of a BN quantify the causal relationship between nodes. Specifically, the parameters 1002 specify the probabilities of one node given the conditions of its parents. In the embodiment in FIG. 10b, the target variable is “PO2” 1012 and the non-target variables are “Pneumonia” 1008 and “Asthma” 1010. The non-target variables for a given target variable may be taken from the structure 1000 of the BN. For instance, in FIG. 10a, “Pneumonia” 1008 and “Asthma” 1010 are parent nodes of “PO2” 1012 and are consequently chosen as non-target variables since they are causally related to “PO2” 1012. The parameters 1002 of the BN then express the probability 1014 that the target variables 1012 (child nodes) have values in different ranges given the values of the non-target variables 1008, 1010 (parent nodes). In this way, the parameters 1002 combined with the structure 1000 combine to form the BN which represents and quantifies the causal relationship between nodes.

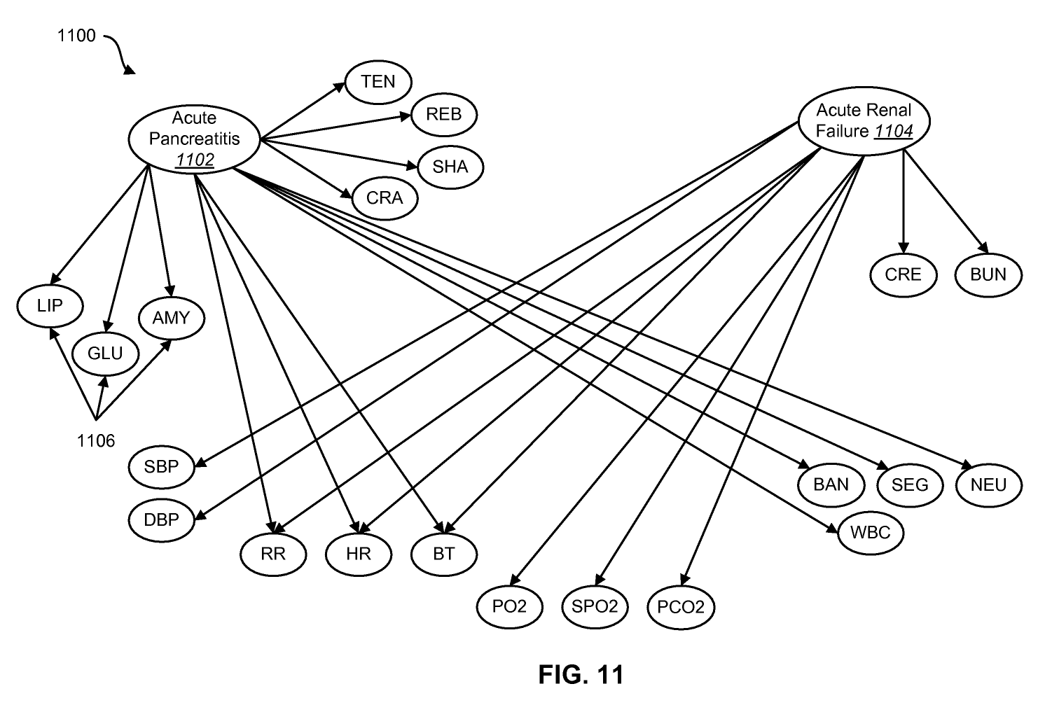

As discussed above, the structure 1000 and the parameters 1002 are built by structural and parameter learning methods, respectively. These learning methods may involve rule-based logic, user input, or machine-learning. However, the probabilities 1014 may later be used by the Bayesian network to suggest a missing value for the target variable (PO2 1012) given the values of the non-target variables (pneumonia 1008 and asthma 1010). Thus, if a parent had asthma and pneumonia, but had no listed value for PO2, the Bayesian network could provide, using its probabilities, the likely value of PO2. Of course, because of the character of Bayesian networks, a value for PO2 could be used by the system to calculate the probabilities of both asthma and pneumonia. FIG. 11 is another embodiment of the structure 1100 of a BN. This structure 1100 may have been created with user input. In other words, a clinician, or someone otherwise skilled in the medical field, uses their knowledge of medicine to compose the structure 1100 (using typical, multi-parent Bayesian Networks). (In naïve Bayes, no node has more than one parent. The example here is not naïve Bayes; it is a typical, multi-parent, Bayesian network.). As in other embodiments, the structure 1100 includes parent nodes 1102, 1104 and child nodes 1106. The nodes and arcs represent a causal relationship. For instance, “Acute Pancreatitis” 1102 is causally related to “LIP,” short for serum lipase, as well as other nodes. In this example, a number of abbreviations are used. These include LIP for serum lipase, GLU for serum glucose, AMY for serum amylase, TEN for abdominal tenderness, REB for rebound tenderness, SHA for sharp abdominal pain, CRA for cramping, CRE for creatinine, BUN for blood urea nitrogen, SBP for systolic blood pressure, DBP for diastolic blood pressure, RR for respiratory rate, HR for heart rate, BT for body temperature, PO2 for pressure of oxygen in the blood, SPO2 for the pressure of oxygen in the blood (measured through the finger (i.e., service of the finger), PCO2 for pressure of carbon oxide in the blood, BAN for band, SEG for segment, WBC for white blood cell count, and NEU for neutrophil. All of the findings represent laboratory values or elements of the physical exam that contributed to the diagnosis of acute pancreatitis, acute renal failure, or both.

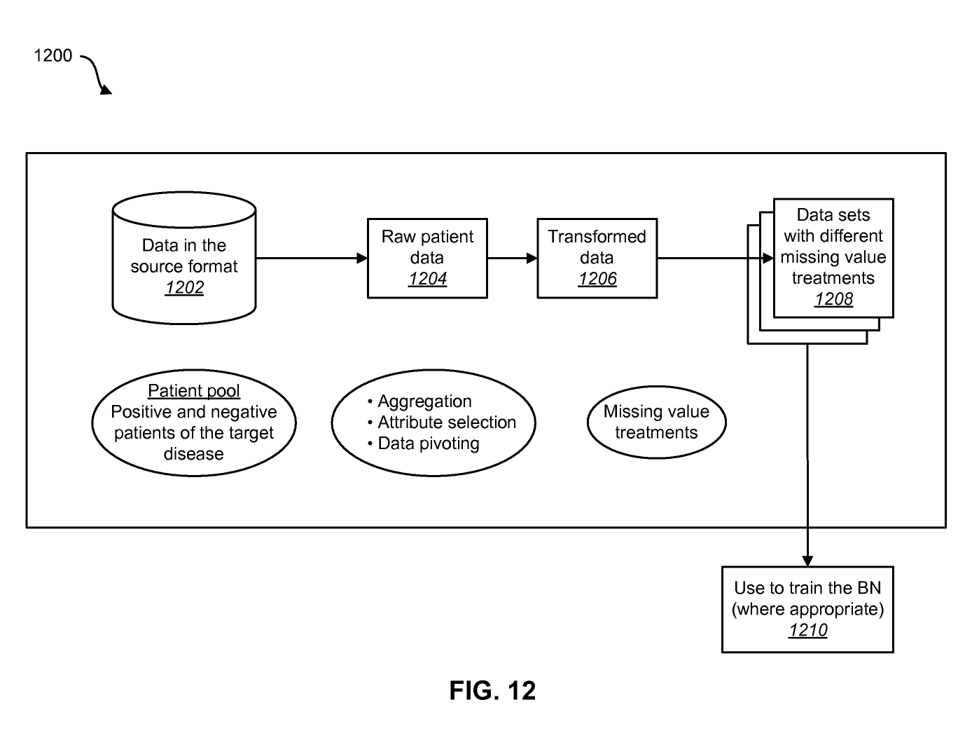

FIG. 12 is a flow diagram illustrating one embodiment 1200 of the way in which data may be taken and then used to train a Bayesian Network. The data may start in a central location accessible to many systems. Alternatively, the data may reside on the same system as the DSS. In a typical embodiment, the data is initially in a source format 1202 specific to the system. Data relating to a target variable, including both positive and negative populations, may then be extracted and combined to form raw patient data 1204. The data may then be transformed 1206 using one or more of data transformation techniques including aggregation, attribute selection, and data pivoting (as discussed herein). Transformation facilitates the use of machine-learning algorithms. Missing value treatments 1208, as discussed above, may then be applied to the transformed data. The data is then ready to be used to train the BN 1210 where the learning methods so require.

It should also be noted that prior to use of the BN, the performance (i.e., specificity and sensitivity) of the prediction engine (BN) may be tested. One method used to test the BN may be to calculate the area under the ROC (Receiver Operating Characteristic) curve. Calculating the area under the ROC curve is a method used in data mining, and as such, some of the exact procedures that may be used are known in the art. For example, each model may be trained to predict the presence or absence of the disease represented as a BN node with a dichotomous value. Training and testing data sets were derived from the treated data set. In the training phase, all information of the training set, including the disease's presence/absence, was provided to train the BN. In the testing phase, (typically using an independent test set) each patient's data, except the disease's presence/absence, was entered into the trained BN to infer the probability of the disease.

Likewise, as described in U.S. Provisional Patent Application Ser. No. 60/867,501 entitled “Exploiting Missing Clinical Data” which was filed Nov. 28, 2006 and is incorporated herein by reference, the learning and training of the BN may also involve cross-validation to evaluate the performance of the BN. This process may include using a bootstrapping process. The bootstrapping approach may be chosen because it is 1) free of underlying distribution assumptions, 2) equal or better in accuracy than classical methods, and 3) simple and intuitive in implementation without using complex statistical formulae. For example, in some embodiments, each derived data set may have a 500 iteration bootstrapping cross-validation process that repeatedly derives data sets for training and testing. During iteration, cases were sampled, with replacement, from the data set; the number of sampled cases was the same as the original data set. This sampled case collection is called the resampled data set. Because cases in the resampled set were sampled with replacement, some cases in the original data set were not selected; this collection is called the residual data set. During each iteration, a Bayesian Network was trained using the resampled data set and tested using both the residual and resampled data sets. A weighted average of AUCs was calculated for each iteration. The AUCs from these iterations were used to compare the accuracy of the systems produced from the different models/data sets. Some results that show the AUCs for some tests conducted are shown in the following tables (Tables 2 and 3).

TABLE 2
(The Average AUCs of Systems Using Randomly Selected Negative Group)

| | | Bayesian Network Learning Scheme | | | | Rank Sum of |
|---|---|---|---|---|---|---|
| | | | | | Human | Treatments C&D |
| | Missing Data | Naïve | | WinMine + | Composed | [possible min, |
| Diagnosis | Treatment | Bayes | WinMine | Netica | Structure | possible max] |
| Acute | A | 0.9572(3) | x | 0.9479(2) | 0.9481(3) | 14 |
| Pancreatitis | B | 0.9433(4) | 0.9459(3) | 0.9458(3) | 0.9294(4) | [12, 26] |
| | C | 0.9818(2) | 0.9881(2) | 0.9881(1) | 0.9816(1) | (p = 0.0278) |
| | D | 0.9818(1) | 0.9887(1) | 0.9420(4) | 0.9816(2) | |
| Acute Renal | A | 0.9905(3) | x | 0.9827(3) | 0.9880(3) | 12 |
| Failure | B | 0.9843(4) | 0.9734(3) | 0.9734(4) | 0.9505(4) | [12, 26] |
| | C | 0.9971(1) | 0.9978(1) | 0.9978(1) | 0.9976(1) | (p = 0.0015) |
| | D | 0.9970(2) | 0.9971(2) | 0.9848(2) | 0.9963(2) | |
| Asthma | A | 0.9758(2) | x | 0.9772(4) | 0.9750(1) | 20 |
| | B | 0.9775(1) | 0.9785(3) | 0.9785(3) | 0.9749(2) | [12, 26] |
| | C | 0.9691(4) | 0.9826(2) | 0.9826(1) | 0.9743(3) | (p = 0.7315) |
| | D | 0.9719(3) | 0.9835(1) | 0.9797(2) | 0.9734(4) | |
| Pneumonia | A | 0.9677(4) | x | 0.9686(4) | 0.9647(4) | 13 |
| | B | 0.9786(3) | 0.9774(3) | 0.9774(2) | 0.9749(3) | [12, 26] |
| | C | 0.9793(2) | 0.9833(2) | 0.9833(1) | 0.9791(1) | (p = 0.0077) |
| | D | 0.9802(1) | 0.9851(1) | 0.9705(3) | 0.9778(2) | |
| Urinary | A | 0.8764(4) | x | 0.8875(3) | 0.8447(4) | 12 |
| Infection | B | 0.8973(3) | 0.8846(3) | 0.8846(4) | 0.8476(3) | [12, 26] |
| | C | 0.9361(2) | 0.9586(2) | 0.9586(1) | 0.9303(1) | (p = 0.0015) |
| | D | 0.9370(1) | 0.9600(1) | 0.9164(2) | 0.9303(2) | |
| | Rank Sum of | 19 | 15 | 18 | 19 | 71 |
| | Treatments C&D | [15, 35] | [15, 25] | [15, 35] | [15, 35] | [60, 130] |
| | [possible min, | (p = 0.0271) | (p = 0.0041) | (p = 0.0104) | (p = 0.0271) | (p = 0.0000) |
| | possible max] | | | | | |

Regarding Table 2, the AUCs are the results of 500 iterations of bootstrapping for training/testing of each data set. The data sets are composed of each disease group of patients and the randomly selected negative group. Missing data treatments include A: original status, B: imputed with general mean, C: “missing” state, and D: “missing” node.

Further regarding Table 2, the numbers in parentheses are the ranks among four missing data treatments for each combination of disease and Bayesian model. In the margin cells, rank sums of Treatments C and D are shown. The numbers in the bracket are the minimums and maximums of all permutations of ranks. The p values were calculated by permutation tests. Note that, because WinMine automatically generates parameters based on explicitly missing values, an analysis of data treatment A used to train WinMine alone is not possible.

TABLE 3
(The Average AUCs of Systems Using the Other Diseases as the Negative Group)

| | | Bayesian Network Learning Scheme | | | | Rank Sum of |
|---|---|---|---|---|---|---|
| | | | | | Human | Treatments C&D |
| | Missing Data | Naïve | | WinMine + | Composed | [possible min, |
| Diagnosis | Treatment | Bayes | WinMine | Netica | Structure | possible max] |
| Acute | A | 0.9623(3) | x | 0.9580(2) | 0.9366(3) | 13 |
| Pancreatitis | B | 0.9333(4) | 0.9157(3) | 0.9157(4) | 0.8841(4) | [12, 26] |
| | C | 0.9863(1) | 0.9880(1) | 0.9880(1) | 0.9847(2) | (p = 0.0077) |
| | D | 0.9862(2) | 0.9846(2) | 0.9358(3) | 0.9848(1) | |
| Acute Renal | A | 0.9779(3) | x | 0.9708(4) | 0.9730(3) | 13 |
| Failure | B | 0.9759(4) | 0.9735(3) | 0.9735(2) | 0.9715(4) | [12, 26] |
| | C | 0.9811(1) | 0.9772(1) | 0.9772(1) | 0.9750(1) | (p = 0.0077) |
| | D | 0.9809(2) | 0.9771(2) | 0.9726(3) | 0.9750(2) | |
| Asthma | A | 0.9034(4) | x | 0.8901(2) | 0.8760(3) | 13 |
| | B | 0.9049(3) | 0.8856(3) | 0.8856(4) | 0.8696(4) | [12, 26] |
| | C | 0.9235(1) | 0.9233(1) | 0.9233(1) | 0.8886(2) | (p = 0.0077) |
| | D | 0.9234(2) | 0.9153(2) | 0.8870(3) | 0.8893(1) | |
| Pneumonia | A | 0.8678(1) | x | 0.8766(2) | 0.8236(1) | 17 |
| | B | 0.8546(4) | 0.8551(3) | 0.8551(4) | 0.8002(4) | [12, 26] |
| | C | 0.8605(3) | 0.8816(1) | 0.8816(1) | 0.8131(2) | (p = 0.2685) |
| | D | 0.8606(2) | 0.8800(2) | 0.8754(3) | 0.8120(3) | |
| Urinary | A | 0.9371(3) | x | 0.9280(2) | 0.8661(3) | 13 |
| Tract | B | 0.9237(4) | 0.9148(3) | 0.9148(4) | 0.8514(4) | [12, 26] |
| Infection | C | 0.9476(1) | 0.9555(1) | 0.9555(1) | 0.8893(2) | (p = 0.0077) |
| | D | 0.9474(2) | 0.9457(2) | 0.9222(3) | 0.8894(1) | |
| | Rank Sum of | 17 | 15 | 20 | 17 | 69 |
| | Treatments C&D | [15, 35] | [15, 35] | [15, 35] | [15, 35] | [60, 130] |
| | [possible min, | (p = 0.0033) | (p = 0.0041) | (p = 0.0594) | (p = 0.0033) | (p = 0.0000) |
| | possible max] | | | | | |

Regarding Table 3, the AUCs are the results of 500 iterations of bootstrapping for training/testing of each data set. The experiment and analysis are identical to that of Table 2, except the data set are composed of each disease group of patients and the other disease groups as the negative group.

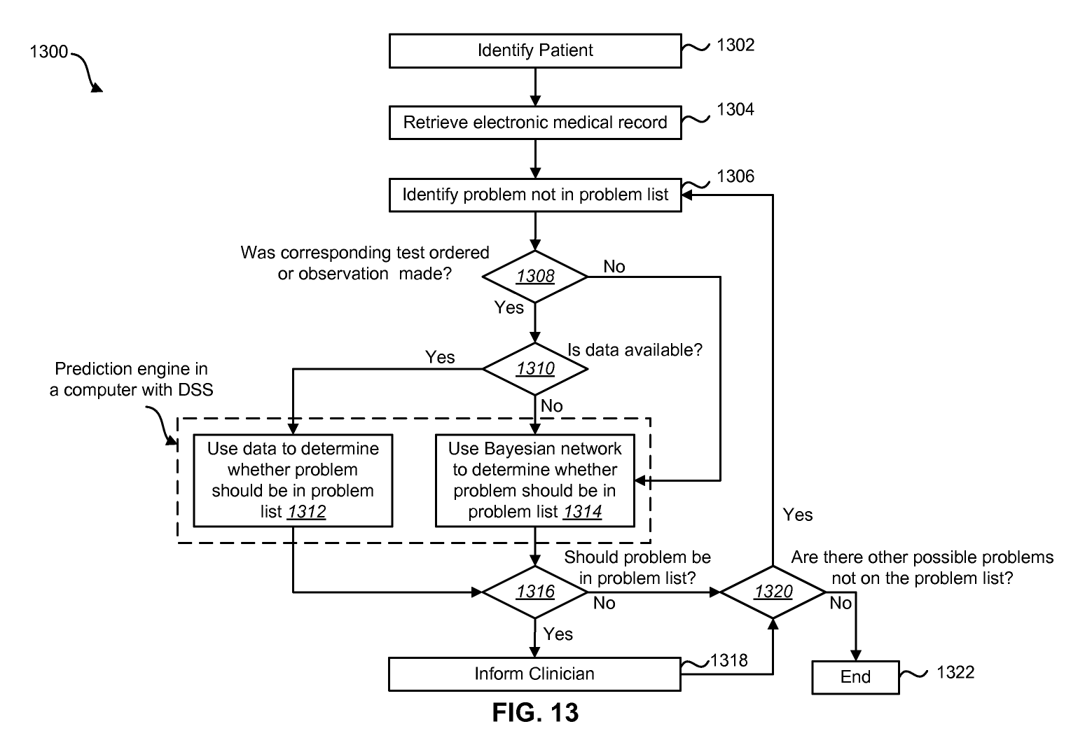

FIG. 13 is a flow diagram of a method 1300 of continuously updating a problem list in an EHR (which may also be referred to as an electronic medical record or “EMR”). This method 1300 may take place in the DSS of a computing system. In a typical embodiment, a clinician instigates the method and receives the results. First, a patient may be identified 1302, and their EMR may be retrieved 1304. The problem, or target variable, that is not in the problem list may then be identified 1306. If no test has been ordered 1308 or no data corresponding to the problem is available 1310, then the data may be sent to the prediction engine to use a BN to determine if the problem should be in the problem list 1314. If, however, there is data corresponding to the problem then the prediction engine may use that data to determine whether the problem should be in the problem list 1312. (It should be noted that the Bayesian network will be used in both cases and will be run using a combination of that data which exists and that data which is missing.) Once the probabilities (that the problem should be in the problem list) are determined 1316, whether using a BN or not, the DSS may inform the clinician 1318. The DSS may then look for another problem, or target variable, that is not in the patient's problem list 1320. If another problem is identified, the process is repeated for that problem. If not, the process ends 1322.

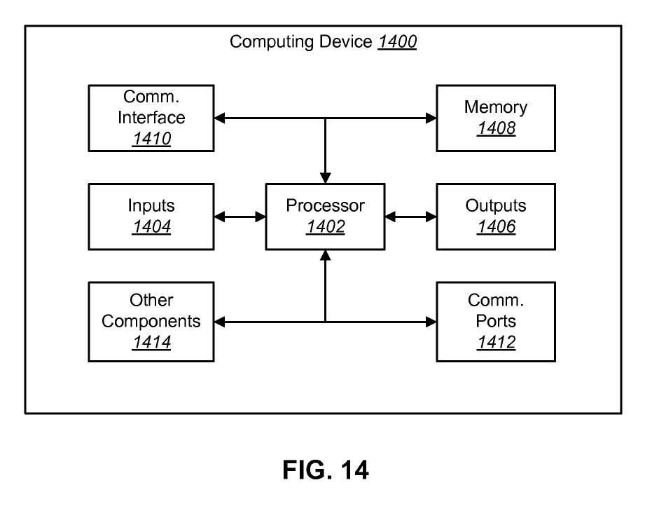

FIG. 14 is a block diagram illustrating the major hardware components typically utilized with embodiments herein. Computing devices 1400 are known in the art and are commercially available. The major hardware components typically utilized in a computing device 1400 are illustrated in FIG. 14. A computing device 1400 typically includes a processor 1402 in electronic communication with input components or devices 1404 and/or output components or devices 1406. The processor 1402 is operably connected to input 1404 and/or output devices 1406 capable of electronic communication with the processor 1402, or, in other words, to devices capable of input and/or output in the form of an electrical signal. Embodiments of computing devices 1400 may include the inputs 1404, outputs 1406 and the processor 1402 within the same physical structure or in separate housings or structures.

The computing device 1400 may also include memory 1408. The memory 1408 may be a separate component from the processor 1402, or it may be on-board memory 1408 included in the same part as the processor 1402. For example, microcontrollers often include a certain amount of on-board memory.

The processor 1402 is also in electronic communication with a communication interface 1410. The communication interface 1410 may be used for communications with other devices 1400. Thus, the communication interfaces 1410 of the various devices 1400 may be designed to communicate with each other to send signals or messages between the computing devices 1400.

The computing device 1400 may also include other communication ports 1412. In addition, other components 1414 may also be included in the electronic device 1400.

Of course, those skilled in the art will appreciate the many kinds of different devices that may be used with embodiments herein. The computing device 1400 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 14 is only meant to illustrate typical components of a computing device 1400 and is not meant to limit the scope of embodiments disclosed herein.

For the embodiments described herein, information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A method for providing information to a clinician regarding a patient's medical problems based upon a combination of information recorded in the medical record and information missing from the medical record, the method comprising:
obtaining a patient's medical record, the medical record comprising:
information regarding the medical conditions experienced by the patient;
information from a clinician's observations of treating or testing the patient;
results from tests or therapies administered to the patient;
obtaining a computer system having a decision support system, wherein the decision support system comprises a prediction engine;
using the decision support system to predict conditions omitted from the patient's medical record; and
providing these predictions to the clinician for recording into the medical record.

2. A method as in claim 1 wherein the prediction engine identifies conditions omitted from the medical records.

3. A method as in claim 2 wherein the prediction engine comprises a Bayesian network.

4. A method as in claim 3 further comprising testing sensitivity and specificity of the predictions provided by the Bayesian network.

5. A method as in claim 4 wherein the sensitivity and specificity of the Bayesian network is tested by creating an ROC curve.

6. A method as in claim 1 further comprising adding a missingness indicator to the patent record to signal to the prediction engine that this value is absent from the medical record.

7. A method as in claim 1 wherein the decision support system further comprises an output engine that outputs the value predicted by the prediction engine to the clinician.

8. A method as in claim 1 wherein the prediction engine makes predictions in a target variable based upon values for non-target variables that are known to have a causal relationship with the target variable.

9. A method as in claim 1 further comprising training the prediction engine using information from a database of medical records.

10. A computer system that is configured to provide information to a clinician regarding a patient's medical problems based upon a combination of information recorded in the medical record and information missing from the medical record, the system comprising;
a processor;
memory in electronic communication with the processor;
instructions stored in the memory, the instructions being executable to:
obtain a patient's medical record that is stored in a database, wherein the medical record is an electronic medical record comprising:
information regarding the medical conditions experienced by the patient;
information from a clinician's observations of treating or testing the patient;
results from tests or therapies administered to the patient;
predict a value for conditions omitted from the patient's medical record using a prediction engine that is part of a decision support system; and
provide these predictions to the clinician for recording into the medical record.

11. A system as in claim 10 wherein the prediction engine comprises a Bayesian network that has been trained to make predictions from the information found in the database.

12. A system as in claim 10 wherein the database is located remotely from the system.

13. A system as in claim 10 wherein the prediction engine makes predictions in a target variable based upon values for non-target variables that are known to have a causal relationship with the target variable.

14. A system as in claim 10 wherein the predictions are sent to the clinician via an output engine.

15. A computer-readable medium comprising executable instructions to:
obtain a patient's medical record that is stored in a database, wherein the medical record is an electronic medical record comprising:
information regarding the medical conditions experienced by the patient;
information from a clinician's observations of treating or testing the patient;
results from tests or therapies administered to the patient;
predict a value for conditions omitted from the patient's medical record using a prediction engine that is part of a decision support system; and
provide these predictions to the clinician for recording into the medical record.

16. A computer-readable medium as in claim 15 wherein the prediction engine comprises a Bayesian network that has been trained to make predictions from the information found in the database.

17. A computer-readable medium as in claim 15 wherein the prediction engine makes predictions in a target variable based upon values for non-target variables that are known to have a causal relationship with the target variable.
